(19) United States
(12) Patent Application Publication
(10) Pub. No.: US 2020/0067065 A1
(43) Pub. Date: Feb. 27, 2020

(54) BATTERY CELL AND METHOD FOR PRODUCING A BATTERY CELL

(71) Applicant: VOLKSWAGEN AKTIENGESELLSCHAFT, Wolfsburg (DE)

(72) Inventors: Alexander BREUER, Celle (DE); Markus RAMM, Braunschweig (DE)

(73) Assignee: VOLKSWAGEN AKTIENGESELLSCHAFT, Wolfsburg (DE)

(21) Appl. No.: 16/552,010

(22) Filed: Aug. 27, 2019

(30) Foreign Application Priority Data
Aug. 27, 2018 (DE) 10-2018-006718.2

(51) Int. Cl. H01M 2/26; H01M 10/0525

(52) U.S. Cl. CPC H01M 2/26; H01M 2220/20; H01M 10/0525

(57) ABSTRACT

The invention relates to a battery cell with a stack of positive and negative electrodes as well as separators arranged between them, whereby the electrodes each have lugs which are each welded to at least one positive arrester and to at least one negative arrester. The electrode lugs are connected to the end face of the arrester by means of a butt joint weld seam. Thanks to the battery cell according to the invention, the installation space in the cell can be better utilized or reduced while maintaining the same capacity.

### FIELD OF THE INVENTION

The present invention relates to a battery cell, especially for lithium-ion traction batteries, particularly for electric vehicles, it also relates to a method for producing such a battery cell.

### BACKGROUND OF THE INVENTION

The state of the art discloses lithium-ion traction batteries that comprise battery cells with a stack of positive and negative electrodes as well as separators arranged between them, whereby the electrodes each have lugs which are each welded to at least one positive arrester and to at least one negative arrester. This structure is typically surrounded by insulating material. The electrodes each have lugs that come out of the stack of electrodes and that are connected, typically welded, to an arrester, also referred to as a collector. By way of an example of this structure, reference is hereby made to German patent application DE 10 2011 109 237 A1. In this context, the structure is configured in such a way that the electrode lugs of the one pole and of the other pole project separately from the stack of positive and negative electrodes as well as separators arranged between them. These lugs are then welded by means of a lap joint to an arrester arranged in a plane parallel to the plane of the stack. In this context, the connection between the collector and the individual lugs of the electrodes is a decisive factor when it comes to ensuring a secure and reliable functionality. For this reason, an ultrasonic welding method is often employed. In order to create secure and reliable connections, it is the case that the welding has to be carried out at very high energy levels, which can put great stress on the electrodes and on the structure of the battery cells during production and which also calls for a relatively high amount of energy.

In an alternative embodiment of the connection of the electrode lugs to the arrester, European patent application EP 2 584 629 A1 proposes that the connection be provided in an indentation in the active material of the battery cell in order to reduce the installation space necessary to accommodate the thickness of the arrester and the stack of electrode lugs.

U.S. Pat. Appln. No. 2014/0079983 A1 describes another possibility for a battery cell of the generic type. The battery cell likewise comprises a stack of positive and negative electrodes as well as separators arranged between them, whereby the electrodes each have lugs which are each welded to at least one positive arrester and to at least one negative arrester. On the opposite side, the arresters project out of a protective sleeve on different sides of the cell. The arresters are configured with multiple layers, including a metallic layer which is situated between an adhesive layer and a non-conductive sealing layer. This is used in such a way that the sealing layer can be concurrently connected to the protective sleeve or else it serves as a protective sleeve in the area where the arrester comes out of the sleeve. In this document, the connection between the electrode lugs and the arresters is generally created in the usual manner, for example, by means of ultrasonic welding with a lap joint.

All prior-art generic battery cells have overlapping areas as the welded connection between the electrode lugs and the arresters, whereby the welded connection is created in these areas by means of a lap joint.

Before this backdrop, one aspect of the present invention is to put forward a battery cell for lithium-ion traction batteries that permits a better utilization of the installation space available. At the same time, it should be achieved that the mechanical and electric stability of the electronic connection between the electrode lugs on the one hand and the arresters on the other hand should be at least as good as these properties are in case of the prior-art connections created by means of a lap joint.

The generic U.S. Pat. No. 9,882,193 B2 discloses a battery cell with a stack of positive and negative electrodes as well as separators arranged between them, whereby the electrodes each have lugs which are each welded to at least one positive arrester and to at least one negative arrester. The electrode lugs are connected to the end face of the arrester by means of a butt joint weld seam created by friction stir welding.

### SUMMARY OF THE INVENTION

The invention is based on the objective of improving the battery cell.

This objective is achieved according to the invention by means of a battery cell having the features of the patent claims.

The invention comprises a battery cell with a stack of positive and negative electrodes as well as separators arranged between them, whereby the electrodes each have lugs which are each welded to at least one positive arrester and to at least one negative arrester. The electrode lugs are connected to the end face of the arrester by means of a butt joint weld seam.

The term welding joint refers to the area where welded parts are joined together. There are various types of joints which are standardized in ISO 17659 and which differ in terms of the structural arrangement of the workpieces or of their end surfaces. In a butt joint weld seam, the end faces of the workpieces to be joined are situated directly opposite from each other. In other words, the end faces of the parts that are to be joined by welding—in this case, the end faces of the electrode lugs on the one hand and the end face(s) of the arrester(s) on the other hand—abut each other and the parts are opposite from each other in the same plane. A butt joint does not have an overlapping area between the parts that are to be joined.

Advantageously, the geometry of the butt joint weld seam according to the invention that serves to connect the electrode lugs to the arrester or arresters—which are configured as electric, that is to say, positive and negative connections—can bring about an improved utilization of the installation space in the battery cell. Thanks to the elimination of the previous, conventional overlapping area of the electrode lugs and the arresters, the installation space that has now become available can be utilized to increase the capacity of the battery cell while maintaining the same dimensions or else to reduce the dimensions of the battery cell while maintaining the same capacity.

Moreover, the force lines run through butt seams with a relatively uniform stress distribution, as a result of which stress peaks can be avoided and the mechanical stability is also good since the parts do not shift relative to each other when they are exposed to external forces.

Differences in thickness between the electrode lugs and the arresters can be compensated for to a certain extent. In this context, preference should be given to a symmetrical arrangement of the thinner component relative to the thicker component. If a lower requisite dynamic strength is possible, then an asymmetrical arrangement of the electrode lugs relative to the arrester is likewise possible.

In an embodiment of the battery cell according to the invention, the end face connection is created means of laser beam welding or electron beam welding. When it comes to large-scale serial production, the option to choose between electron beam welding and laser beam welding—both of which can be equally successfully employed for the production according to the invention of the butt joint weld seam between the electrode lugs and the arresters—is particularly advantageous. Moreover, other welding methods such as metal inert gas (MIG) welding, tungsten inert gas (TIG) welding and/or plasma welding can also be used.

In an embodiment of the battery cell according to the invention, the weld seam for connecting the end faces of the electrode lugs to the arrester is configured on one side or on both sides.

Owing to the electric and thermal requirements made of the contacting thus created, it is absolutely necessary for all of the electrode lugs to be connected to the arrester. For this purpose, depending on the thickness ratio and on the overall thickness of the parts being joined, one-sided full penetration welding or two-sided welding can be carried out. In the case of two-sided welding, the two weld roots should overlap in order to avoid any non-contacted electrode lugs.

In an embodiment of the battery cell according to the invention, the battery cell can have a protective sleeve in which the stack is arranged together with an electrolyte, whereby the weld seam for the end-face connection of the electrode lugs to the arresters is arranged inside the protective sleeve.

The protective sleeve can be in the form of a foil or a foil bag that can consist of insulating material or of a multilayered metal foil surrounded by insulating material. The components of the battery cell along with the electrolyte are tightly encapsulated in the protective sleeve. Such a structure of the battery cell as a so-called pouch or coffee bag cell is very simple and efficient since, after the stack of electrodes and separators has been welded to the arresters, it can be welded into a foil bag or into two foils laid against each other above or below the stack. Therefore, the structure can be easily and efficiently insulated and sealed fluid-tight, so that the electrolyte filled into the bag or between the foils is held securely and reliably in this area.

In an embodiment of the battery cell according to the invention, the arresters can project out of the protective sleeve.

The weld seam for the connection of the electrode lugs to the arresters is arranged inside the protective sleeve and only the area of the arresters needed for the further electric connection of the battery cell projects out of the protective sleeve. In this manner, the weld seam is well protected against external influences. When a stacking is made in order to form a battery consisting of battery cells, the areas of the arresters situated outside of the protective sleeve can be connected to corresponding conductor rails in order to interconnect the individual battery cells with each other in parallel and/or in series.

In an embodiment of the battery cell according to the invention, the end faces of the electrode lugs are connected in groups to the arrester.

This embodiment can be particularly advantageous if the thickness difference between the foil stack and the arrester becomes too large since the thickness difference cannot be sufficiently compensated for by the weld seam. For this reason, it can be advantageous for the electrode lug stack having a given polarity to be configured in such a way that it projects out of the stack of electrodes in at least two groups in at least two different areas, and so that each of the groups is welded to a different area of the appertaining arrester. The heat input into the relatively sensitive battery cell is also correspondingly reduced if the welding has been done so well that there is a very good electric connection of the electrode lugs to the arrester. Moreover, this structure allows a correspondingly large number of electrodes to be processed in each battery cell since the electrode lugs can be welded in the individual groups to the arrester so that all in all, a larger number of individual electrode lugs can be securely and reliably welded to the arrester. In this manner, the power density of a battery made up of battery cells can be enhanced.

In an embodiment of the battery cell according to the invention, the battery cell is a lithium-ion battery or a lithium-polymer battery. These types of battery cells find widespread use, particularly in a pouch format.

Another subject matter of the battery cell according to the invention is a method for producing a battery cell, comprising the following steps:
providing a stack of positive and negative electrodes as well separators arranged between them, whereby the electrodes each have lugs,
welding each of the lugs of the positive and negative electrodes to at least one positive arrester and to at least one negative arrester,
inserting the stack with the arresters welded to the electrode lugs into a protective sleeve in such a way that the weld seam is arranged between the electrode lugs and the arresters inside the protective sleeve, and the arresters project out of the protective sleeve,
filling in an electrolyte, and,
sealing the protective sleeve,

whereby the electrode lugs are each connected to the end face of the arrester by means of butt joint welding, whereby the end-face connection is created by means of laser beam welding or electron beam welding, tungsten inert gas (TIG) welding, metal inert gas (MIG) welding or plasma welding.

Advantageously, the step of the butt joint welding according to the invention that serves to connect the electrode lugs to the arrester or arresters—which are configured as electric, that is to say, positive and negative connections—can bring about an improved utilization of the installation space in the battery cell. Thanks to the elimination of the previous, conventional overlapping area of the electrode lugs and the arresters, the installation space that has now become available can be utilized to increase the capacity of the battery cell while maintaining the same dimensions or else to reduce the dimensions of the battery cell while maintaining the same capacity.

Moreover, the force lines run through butt seams with a relatively uniform stress distribution, as a result of which stress peaks can be avoided and the mechanical stability is also good since the parts do not shift relative to each other when they are exposed to external forces.

Differences in thickness between the electrode lugs and the arresters can be compensated for to a certain extent. In this context, preference should be given to a symmetrical arrangement of the thinner component relative to the thicker component. If a lower requisite dynamic strength is possible, then an asymmetrical arrangement of the electrode lugs relative to the arrester is likewise possible.

It is likewise a subject matter of the present invention that the battery cell or the method for producing a battery cell according to the present invention is employed to create a cell stack as a traction battery in a vehicle that is powered at least partially electrically.

The battery cell according to the invention can be structured easily and efficiently, allowing a comparatively improved capacity or a reduction of the installation space in each battery cell. This makes it possible to cost-effectively produce very powerful batteries in a simple and efficient manner. This is particularly advantageous for use in traction batteries for vehicles that are powered at least partially electrically since, in view of the anticipated production volume and of the costs associated with the battery, any advantages in terms of efficient production, high power density and a secure as well as reliable structure are especially important.

There are numerous possibilities to configure and refine the battery cell. For this purpose, reference is hereby first made to the patent claims subordinate to patent claim 1.

### BRIEF DESCRIPTION OF THE DRAWINGS

A preferred embodiment of the invention will be explained in greater detail below on the basis of the drawings and of the accompanying descriptions. The drawings show the following:

FIG. 1: a highly schematic depiction of a generic battery cell in a general configuration;

FIG. 2: as a sectional view, a highly schematic depiction of an arrangement of the connection of the electrode lugs of an electrode stack to an arrester according to the state of the art;

FIG. 3: as a sectional view, a highly schematic depiction of an arrangement of the connection of the electrode lugs of the electrode stack to an arrester according to the present invention;

FIG. 4: as a sectional view, a highly schematic depiction of an arrangement of the connection of the electrode lugs of the electrode stack to an arrester according to another embodiment of the present invention;

FIG. 5: as a sectional view, a highly schematic depiction of an arrangement of the connection of the electrode lugs of the electrode stack to an arrester according to another embodiment of the present invention;

FIG. 6: as a sectional view, a highly schematic depiction of an arrangement of the connection of the electrode lugs of the electrode stack to an arrester according to another embodiment of the present invention.

### DETAILED DESCRIPTION OF THE INVENTION

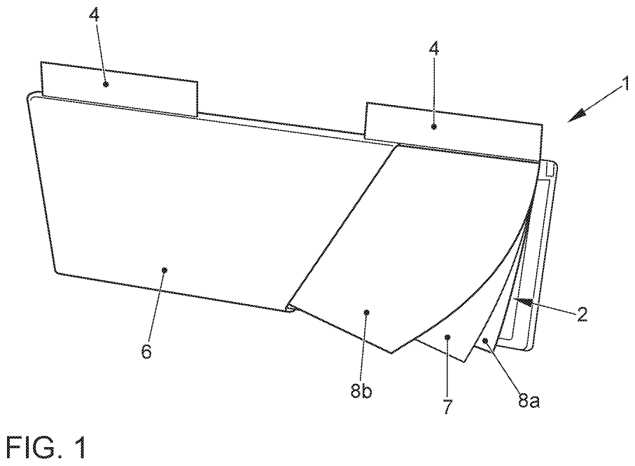

FIG. 1 shows a battery cell 1 with a stack 2 of positive and negative electrodes 8a, 8b as well as separators 7 arranged between them, whereby the electrodes 8 are each welded to at least one positive arrester 4 and to at least one negative arrester 4. The battery cell 1 has a protective sleeve 6 in which the stack 2 is arranged, normally along with an electrolyte. The arresters 4 partially project out of the protective sleeve 6. The battery cell 1 can be a lithium-ion battery or a lithium-polymer battery.

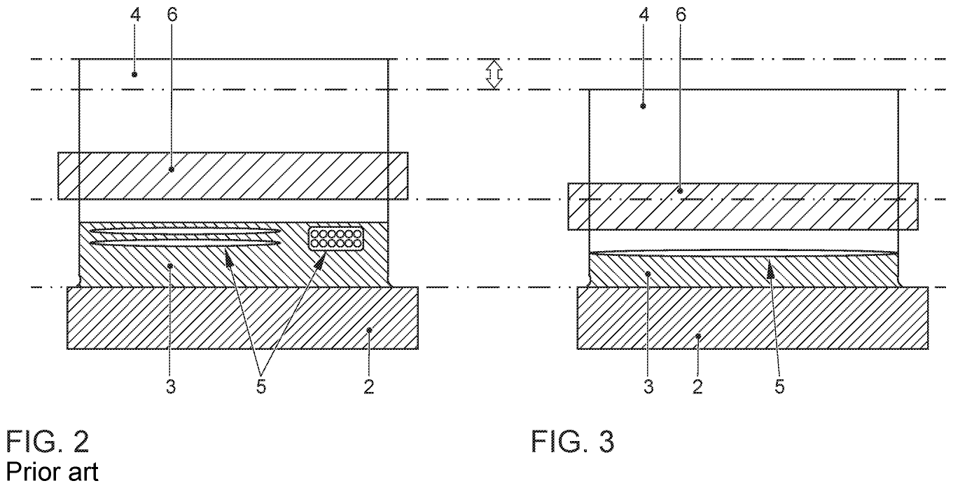

As a detailed view of a generic battery cell 1, FIG. 2 schematically shows the usual arrangement of the connection 5 of the electrode lugs 3 to an arrester 4 according to the state of the art. The electrode lugs 3 extend from the electrode stack 2 in the direction of the arrester 4 and they are connected to the arrester 4 by means of one or more weld seams 5. The arrester 4 extends to the outside through a protective sleeve 6 that is shown here only in a highly schematic depiction. On the basis of the arrangement according to the state of the art, an overlapping area is provided in which the electrode lugs 3 overlap with the arrester 4 and in which the weld seam or seams 5 is/are created. Consequently, this is a lap joint in which the two parts that are to be welded together are arranged one above the other.

In contrast, as a detailed view of a generic battery cell 1, FIG. 3 schematically shows the new arrangement of the connection 5 of the electrode lugs 3 of an electrode stack 2 to an arrester 4 according to the present invention in a preferred embodiment. The electrode lugs 3 extend from the electrode stack 2 in the direction of the arrester 4 and they are connected to the arrester 4 by means of a weld seam 5. The arrester 4 extends to the outside through a protective sleeve 6 that is shown here only in a highly schematic depiction. According to the present invention, the welded connection of the electrode lugs 3 to the arrester 4 is a butt joint weld seam 5. In other words, according to the invention, there is no overlapping area between the parts that are to be joined. The parts that are to be joined are not one above the other, but rather, they are arranged with their end faces abutting each other in the same plane.

A comparison of the arrangements of FIG. 2 to the arrangement according to the invention shown in FIG. 3 clearly shows that there is a reduction in the installation space in the battery cell. Thanks to the elimination of the overlapping area of the electrode lugs 3 and the arrester 4 that had been deemed to be absolutely necessary, the requisite installation space can be reduced while maintaining the same capacity of the battery cell or else the installation space that up until now had been occupied by the overlapping area can be used for power-carrying components such as electrodes and electrolyte, so that the battery cell can have a greater capacity. At the same time, the butt joint welding according to the invention can simplify the process since the welded connection can be created on one side by means of full penetration welding as well as on both sides, in addition to which, aside from ultrasonic welding, it is now also possible to use laser beam welding to create the connection between the electrode lugs 3 and an arrester 4. The force lines in a butt seam run with a relatively uniform stress distribution, as a result of which stress peaks can be avoided.

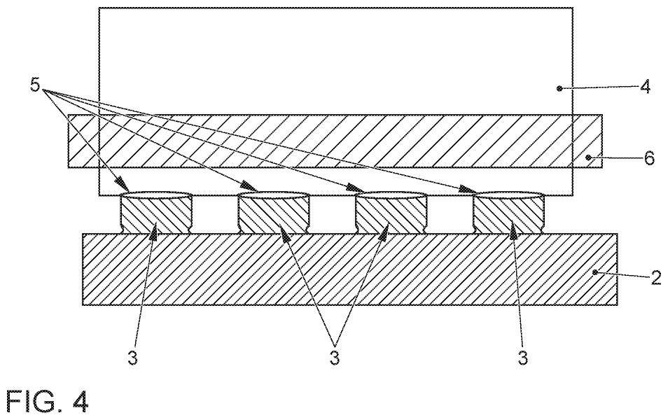

As a sectional view, FIG. 4 shows a highly schematic depiction of an arrangement of the connection 5 of the electrode lugs 3 of the electrode stack 2 to an arrester 5 according to another embodiment of the present invention. Here, too, the connections 5 are created by means of butt joint welding between the end faces of the electrode lugs 3 and the arrester 4. In the embodiment shown, in contrast to the embodiment from FIG. 3, the electrode lugs are arranged in groups. This, in turn, simplifies the process.

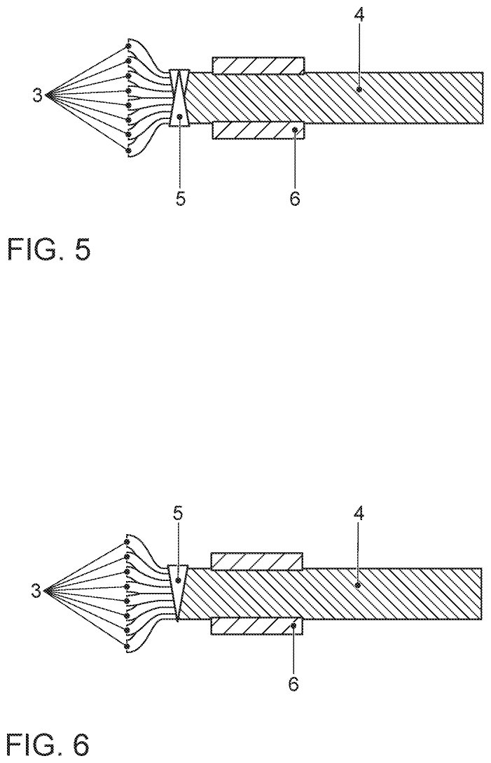

As a sectional view, FIG. 5 shows a highly schematic depiction of an arrangement of the connection 5 of the electrode lugs 3 of an electrode stack to an arrester 4 according to another embodiment of the present invention. The end faces of a group of electrode lugs 3 are connected to the arrester group 4 by means of butt joint welding 5. The butt joint welding here was carried out on both sides, thus allowing a well-controlled process management using laser beam welding or electron beam welding, tungsten inert gas (TIG) welding, metal inert gas (MIG) welding and/or plasma welding. In the case of two-sided welding, the two weld roots should overlap in order to avoid any non-contacted electrode lugs.

As a sectional view, FIG. 6 shows a highly schematic depiction of an arrangement of the connection 5 of the electrode lugs 3 of the electrode stack to an arrester 4 according to another embodiment of the present invention. Here, too, the end faces of a group of electrode lugs 3 are connected to the arrester 4 by means of butt joint welding 5. The butt joint welding here was carried out only on one side and forms a full penetration weld seam 5.

### LIST OF REFERENCE NUMERALS

1 battery cell
2 stack of electrodes
3 electrode lugs
4 arrester
weld seam
6 protective sleeve
7 separators
8 electrodes

1. A battery cell comprising:
a stack of positive and negative electrodes;
at least one separator arranged between positive and negative electrodes,
whereby the electrodes each have lugs which are each welded to at least one positive arrester and to at least one negative arrester,
whereby each of the electrode lugs is connected to an end face of the corresponding arrester by means of a butt joint weld seam,
wherein the end-face connection is created by means of laser beam welding or electron beam welding, tungsten inert gas (TIG) welding, metal inert gas (MIG) welding or plasma welding.

2. The battery cell according to claim 1, wherein the weld seam for connecting the end faces of the electrode lugs to the arrester is configured on one side or on both sides.

3. The battery cell according to claim 1, wherein end faces of the electrode lugs are connected in groups to the arrester.

4. The battery cell according to claim 1,
further comprising a protective sleeve in which the stack of positive and negative electrodes is arranged together with an electrolyte,
wherein the weld seam for the end-face connection of the electrode lugs to the arresters is arranged inside the protective sleeve.

5. The battery cell according to claim 4, wherein the arresters project out of the protective sleeve.

6. The battery cell according to claim 9, wherein the battery cell is a lithium-ion battery or a lithium-polymer battery.

7. A method for producing a battery cell according to claim 1, comprising the following steps:
providing a stack of positive and negative electrodes as well as at least one separator arranged between positive and negative electrodes, whereby the electrodes each have lugs,
welding each of the lugs of the positive and negative electrodes to at least one positive arrester and to at least one negative arrester,
inserting the stack of positive and negative electrodes with the arresters welded to the electrode lugs into a protective sleeve in such a way that the weld seam for connecting an electrode lugs to an arresters is arranged between the electrode lugs and the arresters inside the protective sleeve, and that the arresters project out of the protective sleeve,
filling in an electrolyte, and,
sealing the protective sleeve,
whereby the electrode lugs are each connected to an end face of the respective arrester by means of butt joint welding, and
wherein the end-face connection is created by means of laser beam welding or electron beam welding, tungsten inert gas (TIG) welding, metal inert gas (MIG) welding or plasma welding.
